(19) United States
(12) Patent Application Publication
(10) Pub. No.: US 2026/0107077 A1
(43) Pub. Date: Apr. 16, 2026

(54) SOLID-STATE IMAGING APPARATUS AND CONTROL METHOD THEREOF, AND ELECTRONIC DEVICE

(71) Applicant: Sony Group Corporation, Tokyo (JP)

(72) Inventor: Kenzaburo Seki, Tokyo (JP)

(21) Appl. No.: 19/112,796

(22) PCT Filed: Oct. 17, 2023
(86) PCT No.: PCT/JP2023/037471

§ 371 Date: Mar. 18, 2025

(30) Foreign Application Priority Data
Nov. 2, 2022 (JP) 2022-176091

(51) Int. Cl. H04N 25/78; H04N 25/704

(52) U.S. Cl. CPC H04N 25/78; H04N 25/704

(57) ABSTRACT

Processing live-view images without a lag is disclosed. In one example, a solid-state imaging apparatus includes a pixel array portion with pixels two-dimensionally arranged, a driving unit configured to control reading of signals generated by the pixels, and a signal processing unit configured to generate a photographed image using read signals of the pixels, in which the driving unit reads first pixels and then second pixels, and the signal processing unit performs processing of reflecting a processing result of processing using the first pixels in the photographed image using the second pixels. The technology can, for example, be applied to a solid-state imaging apparatus including a live-view mode.

### TECHNICAL FIELD

The present disclosure relates to a solid-state imaging apparatus and a control method thereof and to an electronic device and, particularly, to a solid-state imaging apparatus that enables processing to be reflected in a live-view image to be executed without a lag in displaying the live-view image, a control method of the solid-state imaging apparatus, and to an electronic device.

### BACKGROUND ART

An imaging element is known in which normal pixels being pixels for video output and phase difference pixels for focus detection are arranged in a pixel array portion where a plurality of pixels is arrayed in a matrix pattern. An example of such an imaging element separately drives a first period for reading signals of normal pixels and a second period for reading signals of phase difference pixels to improve focus response by shortening the time until detection of a phase difference ends and shortening the time from start of imaging to completion of focus (for example, refer to PTL 1).

Imaging elements have a live-view mode in which a live-view image is displayed on a display for image confirmation. For example, a subject's face area or the like may be superimposed on the live-view image as an attention area.

### CITATION LIST

### Patent Literature

[PTL 1]

JP 2013-223054A

### SUMMARY

### Technical Problem

Conventionally, for example, when superimposing and displaying a subject's face area on a live-view image, since detection processing of the face area requires a certain processing time, either the detected face area is superimposed and displayed on the live-view image of one frame later or the display of the live-view image is delayed by one frame and the detected face area is superimposed on the delayed live-view image.

The present disclosure has been made in consideration of the situation described above and enables processing to be reflected in a live-view image to be executed without a lag in displaying the live-view image.

### Solution to Problem

A solid-state imaging apparatus according to a first aspect of the present disclosure includes:
a pixel array portion configured to have a plurality of pixels that is two-dimensionally arranged in a matrix pattern;
a driving unit configured to control reading of signals generated by the pixels; and
a signal processing unit configured to generate a photographed image using the read signals of the pixels, wherein
the driving unit reads first pixels that are a part of the pixels in the pixel array portion first, and to read, after the first pixels, second pixels that are a part of the pixels in the pixel array portion, and
the signal processing unit performs processing of reflecting a processing result of processing using the first pixels in the photographed image using the second pixels.

A control method of a solid-state imaging apparatus according to a second aspect of the present disclosure includes:
of a solid-state imaging apparatus including a pixel array portion configured to have a plurality of pixels that is two-dimensionally arranged in a matrix pattern, a driving unit, and a signal processing unit,
the driving unit reading first pixels that are a part of the pixels in the pixel array portion first and reading, after the first pixels, second pixels that are a part of the pixels in the pixel array portion, and
the signal processing unit performing processing of reflecting a processing result of processing using the first pixels in a photographed image using the second pixels.

An electronic device according to a third aspect of the present disclosure includes a solid-state imaging apparatus including:
a pixel array portion configured to have a plurality of pixels that is two-dimensionally arranged in a matrix pattern;
a driving unit configured to control reading of signals generated by the pixels; and
a signal processing unit configured to generate a photographed image using the read signals of the pixels, wherein
the driving unit reads first pixels that are a part of the pixels in the pixel array portion first, and to read, after the first pixels, second pixels that are a part of the pixels in the pixel array portion, and
the signal processing unit performs processing of reflecting a processing result of processing using the first pixels in the photographed image using the second pixels.

In the first to third aspects of the present disclosure, in a solid-state imaging apparatus including a pixel array portion configured to have a plurality of pixels that is two-dimensionally arranged in a matrix pattern, a driving unit, and a signal processing unit, first pixels that are a part of the pixels in the pixel array portion are first read, second pixels that are a part of the pixels in the pixel array portion are read after the first pixels, and a processing result of processing using the first pixels is reflected in a photographed image using the second pixels.

The solid-state imaging apparatus and the electronic device may be independent apparatuses or may be modules to be built into another apparatus.

### BRIEF DESCRIPTION OF DRAWINGS

FIG. 1 is a block diagram showing a configuration example of an imaging apparatus as an electronic device to which the technique according to the present disclosure is applied.

FIG. 2 is a diagram showing a schematic configuration of a solid-state imaging apparatus shown in FIG. 1.

FIG. 3 is a diagram showing an equivalent circuit of a pixel.

FIG. 4 is a diagram showing a detailed arrangement example of pixels in a pixel array portion.

FIG. 5 is a diagram showing an array example of color filters in the pixel array portion.

FIG. 6 is a diagram for describing drive control of a live-view mode for comparing with present drive control.

FIG. 7 is a diagram for describing drive control of a live-view mode of the solid-state imaging apparatus shown in FIG. 1.

FIG. 8 is a diagram for describing drive control of the live-view mode of the solid-state imaging apparatus shown in FIG. 1.

FIG. 9 is a flow chart for describing drive control processing in the live-view mode of the solid-state imaging apparatus shown in FIG. 1.

FIG. 10 is a diagram showing an example of use of an image sensor.

### DESCRIPTION OF EMBODIMENTS

Hereinafter, a mode (hereinafter, referred to as an embodiment) for implementing the technique according to the present disclosure will be described with reference to the accompanying drawings. In the present specification and the drawings, components having substantially the same functional configuration will be denoted by same reference signs and overlapping descriptions thereof will not be repeated. The descriptions will be given in the following order.
1. Configuration example of imaging apparatus
2. Schematic configuration example of solid-state imaging apparatus
3. Circuit configuration example of pixel
4. Pixel arrangement example of pixel array portion
5. Drive control of live-view mode
5.1 Live-view mode drive by comparative drive control
5.2 Live-view mode drive by solid-state imaging apparatus
5.3 Processing flow of live-view mode drive control
6. Conclusion
7. Example of use of image sensor

### 1. Configuration Example of Imaging Apparatus

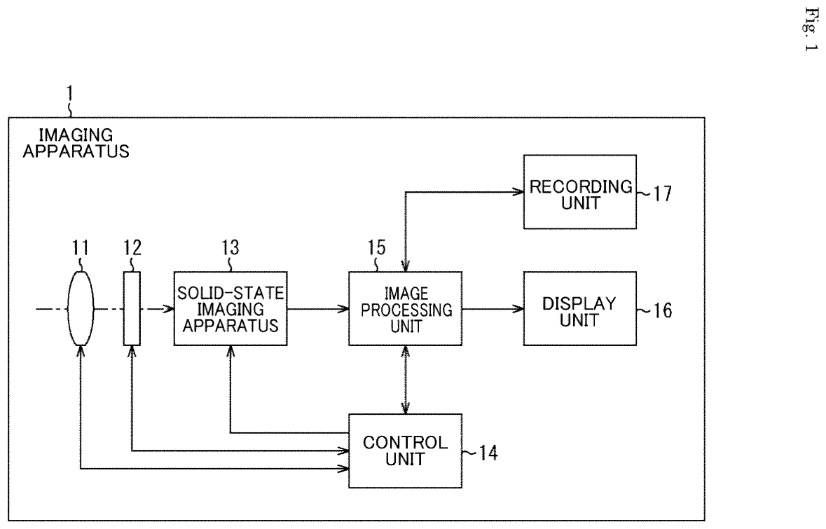

FIG. 1 is a block diagram showing a configuration example of an imaging apparatus as an electronic device to which the technique according to the present disclosure is applied.

An imaging apparatus 1 shown in FIG. 1 is made of a device such as a digital single lens camera, a digital still camera, a digital video camera, a mobile phone, or a multifunctional mobile phone.

The imaging apparatus 1 is constituted of an optical system 11, a shutter apparatus 12, a solid-state imaging apparatus 13, a control unit 14, an image processing unit 15, a display unit 16, and a recording unit 17 and is capable of capturing still images and moving images.

The optical system 11 is constituted of a single lens or a plurality of lenses, guides light (incident light) from a subject to the solid-state imaging apparatus 13, and causes an image to be formed on a light-receiving surface of the solid-state imaging apparatus 13.

The shutter apparatus 12 is arranged between the optical system 11 and the solid-state imaging apparatus 13 and controls a light irradiation period and a shading period with respect to the solid-state imaging apparatus 13 in accordance with control of the control unit 14.

The solid-state imaging apparatus 13 includes a light-receiving surface provided with a plurality of pixels and generates and accumulates signal charges for a certain period in accordance with light that is focused on the light-receiving surface via the optical system 11 and the shutter apparatus 12. The solid-state imaging apparatus 13 generates an image obtained by photoelectrically converting light from the subject and supplies the generated image to the image processing unit 15.

Images photographed by the solid-state imaging apparatus 13 particularly include recorded images and live-view images. A recorded image is an image that is photographed by a user's recording start operation such as a shutter button operation for the purpose of recording the image for viewing or other purposes. The recorded image may be a still image or a moving image. In contrast, a live-view image is a moving image for checking that is presented to the user in advance in order to check an angle of view or the like of a recorded image to be photographed before the recorded image is photographed. A live-view image is also referred to as a through-image and the like.

The control unit 14 controls operations of the imaging apparatus 1 as a whole in accordance with an operation signal or the like that is supplied from an operation input unit (not illustrated). For example, the control unit 14 drives the imaging lens of the optical system 11 to perform focus control or drives the shutter apparatus 12. In addition, the control unit 14 switches between operating modes of the solid-state imaging apparatus 13. For example, the operating modes include a live-view mode in which a live-view image is generated and displayed on the display unit 16, a recording mode in which a recorded image is generated and recorded in the recording unit 17, and a playback mode in which a moving image or a still image recorded in the recording unit 17 is displayed on the display unit 16.

The image processing unit 15 performs predetermined processing in accordance with an operating mode supplied from the control unit 14. Specifically, in the live-view mode, the image processing unit 15 outputs a live-view image output from the solid-state imaging apparatus 13 to the display unit 16 and, in the recording mode, the image processing unit 15 outputs a recorded image output from the solid-state imaging apparatus 13 to the recording unit 17. In addition, in the playback mode, the image processing unit 15 outputs a moving image or a still image supplied from the recording unit 17 to the display unit 16 and causes the display unit 16 to display the image. The image processing unit 15 can output an image output from the solid-state imaging apparatus 13 or an image supplied from the recording unit 17 to the respective units in the subsequent stages after subjecting the image to predetermined image processing.

For example, the display unit 16 is constituted of a thin display such as an LCD (Liquid Crystal Display) or an organic EL (Electro Luminescence) display and displays a moving image or a still image photographed by the solid-state imaging apparatus 13. The recording unit 17 includes a recording medium such as a hard disk or a semiconductor memory and records the moving image or the still image photographed by the solid-state imaging apparatus 13 in the recording medium.

### 2. Schematic Configuration Example of Solid-State Imaging Apparatus

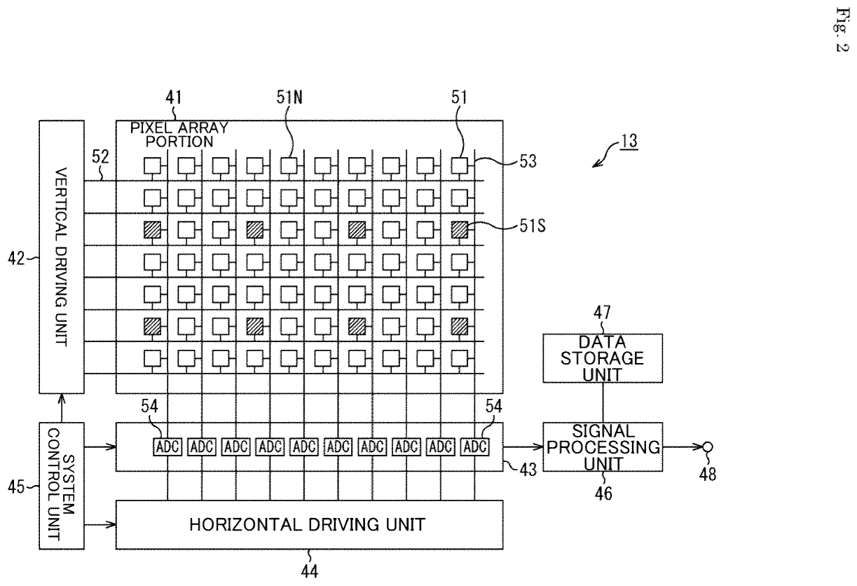

FIG. 2 is a diagram showing a schematic configuration of the solid-state imaging apparatus 13 shown in FIG. 1.

The solid-state imaging apparatus 13 represents, for example, a configuration of a CMOS image sensor that is a type of a solid-state imaging apparatus adopting an X-Y address system. The CMOS image sensor is an image sensor manufactured by applying or partially using a CMOS process.

The solid-state imaging apparatus 13 includes a pixel array portion 41 and a peripheral circuit portion. For example, the peripheral circuit portion includes a vertical driving unit 42, a column processing unit 43, a horizontal driving unit 44, and a system control unit 45.

The solid-state imaging apparatus 13 further includes a signal processing unit 46 and a data storage unit 47. The signal processing unit 46 and the data storage unit 47 may be mounted to the same substrate as the pixel array portion 41, the vertical driving unit 42, and the like or arranged on a separate substrate. In addition, the signal processing unit 46 and the data storage unit 47 may be constituted of a DSP (Digital Signal Processor) or the like on a semiconductor chip separate from the solid-state imaging apparatus 13.

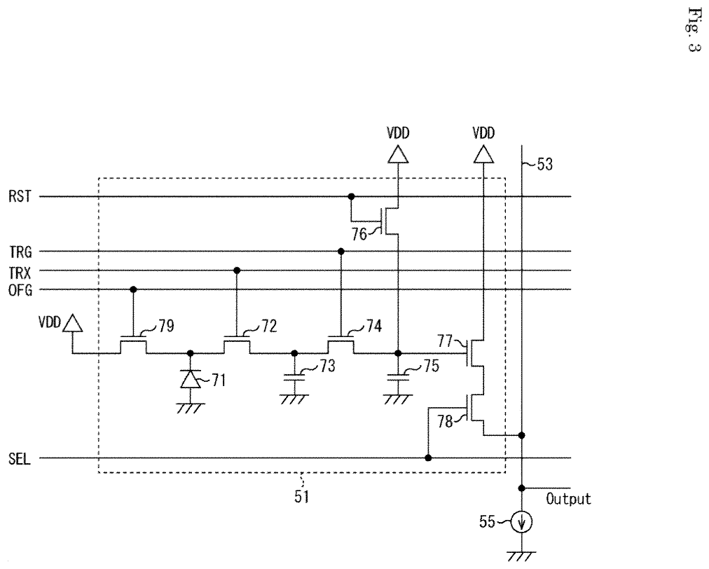

The pixel array portion 41 is configured such that pixels 51 including a photoelectric conversion unit (for example, a photodiode) that generates an electric charge in accordance with an amount of received light are two-dimensionally arranged in a row direction and a column direction in a matrix pattern. In this case, the row direction refers to an array direction of pixel rows of the pixel array portion 41 or, in other words, an array direction of the horizontal direction, and the column direction refers to an array direction of pixel columns of the pixel array portion 41 or, in other words, an array direction of the vertical direction. A circuit configuration example of the pixels 51 will be described later with reference to FIG. 3.

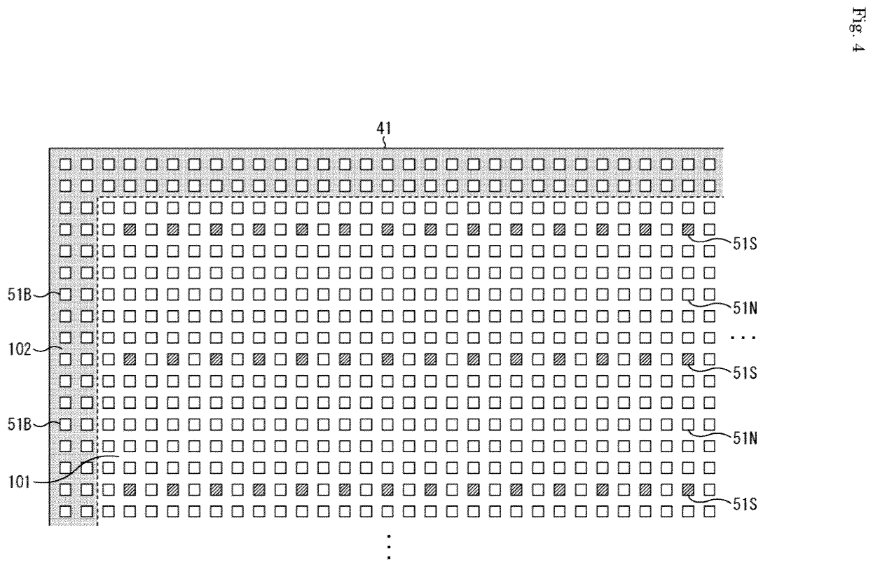

Two types of pixels 51, namely, normal pixels 51N and phase difference pixels 51S are arranged in a mixed manner in the pixel array portion 41. The normal pixels 51N are pixels that acquire and output a pixel signal for video output and the phase difference pixels 51S are pixels that output a phase difference signal for focus control by pupil division of a light-receiving area with a light-shielding film. Note that the phase difference signal obtained by the phase difference pixels 51S may be used as a signal for video output. A detailed arrangement of the pixels 51 in the pixel array portion 41 will be described later with reference to FIG. 4 and the like.

In the pixel array portion 41, a pixel drive wiring 52 as a row signal line is arranged in the row direction for each pixel row and a vertical signal line 53 as a column signal line is arranged in the column direction for each pixel column. The pixel drive wiring 52 transmits a drive signal for performing drive when reading signals from the pixels 51. While the pixel drive wiring 52 is shown as a single wiring in FIG. 2, the pixel drive wiring 52 is not limited to a single wiring. One end of the pixel drive wiring 52 is connected to an output terminal corresponding to each row of the vertical driving unit 42.

The vertical driving unit 42 is constituted of a shift register, an address decoder, or the like and drives the respective pixels 51 of the pixel array portion 41 all at once or in units of rows or the like. Together with the system control unit 45, the vertical driving unit 42 constitutes a driving unit that controls operation of each pixel 51 of the pixel array portion 41. While a specific configuration of the vertical driving unit 42 will not be illustrated, generally, the vertical driving unit 42 includes two scan systems: a read scanning system and a sweep scanning system.

The read scanning system selectively scans the pixels 51 of the pixel array portion 41 in row units in order to read signals from the pixels 51. The signals to be read from the pixels 51 are analog signals. The sweep scanning system performs, with respect to a read line to be subjected to a read scan by the read scanning system, a sweep scan so as to precede the read scan by an exposure time.

The sweep-out scanning performed by the sweep-out scanning system sweeps unnecessary charges from the photoelectric conversion units of the unit pixels 51 in a reading row, thereby resetting the photoelectric conversion unit of each unit pixel 51. A so-called electronic shutter operation is performed by sweeping (resetting) the unnecessary charges performed by the sweep-out scanning system. Here, the electronic shutter operation denotes an operation of discarding charges of the photoelectric conversion units and newly starting exposure (starting accumulation of charges).

A signal read by a read operation by the read scanning system corresponds to an amount of light received since the immediately preceding read operation or electronic shutter operation. In addition, a period from a read timing by a previous read operation or a sweep timing by an electronic shutter operation to a read timing by the current read operation is an exposure period in the pixels 51.

The signal output from each pixel 51 of the row selectively scanned by the vertical driving unit 42 is input to the column processing unit 43 through each vertical signal line 53 for each column. The column processing unit 43 includes an ADC (Analog-Digital Converter) 54 for each column of the pixel array portion 41. The ADC 54 executes CDS (Correlated Double Sampling) processing and AD conversion processing. CDS processing removes pixel-specific fixed pattern noise such as reset noise and threshold variations of amplifying transistors in the pixel. AD conversion processing converts an analog pixel signal into a digital signal. The digital pixel signal after AD conversion is temporarily stored in the ADC 54 until the digital pixel signal is read.

The horizontal driving unit 44 is constituted of a shift register, an address decoder, or the like and sequentially selects the ADC 54 provided in column units in the column processing unit 43. Due to the selective scan by the horizontal driving unit 44, pixel signals held inside of the ADC 54 in the column processing unit 43 are sequentially output to the signal processing unit 46.

The system control unit 45 is constituted of a timing generator that generates various kinds of timing signals and performs drive control of the vertical driving unit 42, the column processing unit 43, the horizontal driving unit 44, and the like based on the various timings generated by the timing generator. Mode information that designates an operating mode such as the live-view mode or the recording mode is supplied to the system control unit 45 from the control unit 14 of the imaging apparatus 1 and the system control unit 45 performs control so as to drive the pixel array portion 41 in accordance with the operating mode.

The signal processing unit 46 at least includes an arithmetic processing function and performs various kinds of signal processing such as arithmetic processing with respect to pixel signals output from the column processing unit 43. For example, the signal processing unit 46 can perform signal processing of generating a focus control signal using phase difference signals of a pair of phase difference pixels 51S of which light-shielding areas are symmetrical. In addition, for example, the signal processing unit 46 can perform signal processing such as black level adjustment and column variation correction using pixel signals obtained from the normal pixels 51N. Furthermore, for example, the signal processing unit 46 can perform processing of detecting a subject's face area or pupil area as an attention area using AI (artificial intelligence) or the like. The data storage unit 47 temporarily stores data necessary for signal processing by the signal processing unit 46. A pixel signal subjected to signal processing in the signal processing unit 46 is converted into a predetermined format and output from an output unit 48 to the outside of the apparatus.

### 3. Circuit Configuration Example of Pixel

FIG. 3 shows an equivalent circuit of the pixel 51.

The pixel 51 includes a photodiode 71, a first transfer transistor 72, a memory unit (MEM) 73, a second transfer transistor 74, an FD (floating diffusion) 75, a reset transistor 76, an amplifying transistor 77, a selective transistor 78, and a discharge transistor 79.

The photodiode 71 is a photoelectric conversion unit that generates an electric charge (signal charge) in accordance with received light intensity. An anode terminal of the photodiode 71 is grounded and a cathode terminal of the photodiode 71 is connected to the memory unit 73 via the first transfer transistor 72. In addition, the cathode terminal of the photodiode 71 is also connected to the discharge transistor 79.

When the first transfer transistor 72 is turned on by a transfer signal TRX, the first transfer transistor 72 reads an electric charge generated by the photodiode 71 and transfers the electric charge to the memory unit 73. The memory unit 73 is an electric charge holding unit that temporarily holds the electric charge until the electric charge is transferred to the FD 75. When the second transfer transistor 74 is turned on by a transfer signal TRG, the second transfer transistor 74 transfers the electric charge held in the memory unit 73 to the FD 75.

The FD 75 is an electric charge-to-voltage conversion unit that converts the electric charge read from the memory unit 73 into a voltage. When the reset transistor 76 is turned on by a reset signal RST, the reset transistor 76 resets a potential of the FD 75 as the electric charge held in the FD 75 is discharged to a constant voltage source VDD.

The amplifying transistor 77 outputs a pixel signal according to the electric potential of the FD 75. In other words, the amplifying transistor 77 configures a source follower circuit together with a load MOS 55 as a constant current source, and a pixel signal representing a level corresponding to electric charge stored in the FD 75 is output from the amplifying transistor 77 to the column processing unit 43 (FIG. 2) through the selective transistor 78. For example, the load MOS 55 is provided inside of the column processing unit 43.

The selective transistor 78 is turned on when the pixel 51 is selected by the selection signal SEL and outputs a signal of the pixel 51 to the column processing unit 43 via the vertical signal line 53. When the discharge transistor 79 is turned on by a discharge signal OFG, the discharge transistor 79 discharges an unnecessary electric charge accumulated in the photodiode 71 to the constant voltage source VDD. The transfer signals TRX and TRG, the reset signal RST, the selection signal SEL, and the discharge signal OFG are controlled by the vertical driving unit 42 and supplied via the pixel drive wiring 52 (FIG. 2).

An operation of the pixel 51 will now be briefly described.

First, before exposure starts, the discharge transistor 79 is turned on as a high-level discharge signal OFG is supplied to the discharge transistor 79 and an unnecessary electric charge accumulated in the photodiode 71 is discharged to the constant voltage source VDD to reset the photodiode 71.

After the photodiode 71 is reset, exposure is started at all pixels when the discharge transistor 79 is turned off by a low-level discharge signal OFG.

Once a predetermined exposure time set in advance has elapsed, the first transfer transistor 72 is turned on by the transfer signal TRX in all pixels of the pixel array portion 41 and the electric charge accumulated in the photodiode 71 is transferred to the memory unit 73.

After the first transfer transistor 72 is turned off, the electric charge held in the memory unit 73 of each pixel 51 is sequentially read to the column processing unit 43 in units of rows. As a read operation, first, the second transfer transistor 74 of the pixel 51 of a read row is turned on by the transfer signal TRG and the electric charge held in the memory unit 73 is transferred to the FD 75. In addition, due to the selective transistor 78 being turned on by the selection signal SEL, a signal indicating a level corresponding to the electric charge held in the FD 75 is output from the amplifying transistor 77 to the column processing unit 43 via the selective transistor 78.

The pixel 51 with the pixel circuit described above is capable of an operation (imaging) according to a global shutter system in which the exposure time is set the same for all pixels in the pixel array portion 41, the electric charge is temporarily held in the memory unit 73 after the exposure is completed, and the electric charge is sequentially read from the memory unit 73 in units of rows.

Note that the circuit configuration of the pixel 51 is not limited to the configuration shown in FIG. 3 and, for example, a circuit configuration that does not have the memory unit 73 and operates according to a so-called rolling shutter system can be adopted.

### 4. Pixel Arrangement Example of Pixel Array Portion

FIG. 4 is a detailed arrangement example of the pixels 51 in the pixel array portion 41.

The pixel array portion 41 includes a plurality of pixels 51 two-dimensionally arranged in a matrix pattern. The plurality of pixels 51 are arranged in an effective pixel region 101 located in a central part of the pixel array portion 41 and an OPB pixel region 102 located in an outer peripheral portion of the pixel array portion 41. In FIG. 4, the OPB pixel region 102 is colored in gray and a boundary between the effective pixel region 101 and the OPB pixel region 102 is depicted by a dashed line.

Pixels 51 are arranged in the effective pixel region 101. The pixels 51 are either normal pixels 51N or phase difference pixels 51S. Although how the phase difference pixels 51S are arranged is not particularly limited, in the example shown in FIG. 4, a phase difference row in which phase difference pixels 51S are arranged is arranged every five rows with respect to the pixel array portion 41 in which the pixels 51 are two-dimensionally arranged in a matrix pattern, and in each phase difference row, the phase difference pixels 51S and the normal pixels 51N are arrayed alternately in the horizontal direction. The phase difference pixels 51S include pixels with a direction of pupil division set in the vertical direction (column direction), the horizontal direction (line direction), and a diagonal direction.

OPB pixels 51B on which a light-shielding film is formed are arranged over the entire OPB pixel region 102. The OPB pixels 51B are pixels that are driven in a similar manner to the normal pixels 51N in the effective pixel region 101 and that detect a black-level reference signal. While the example shown in FIG. 4 represents an example in which two rows of the pixels 51 in a vicinity of an upper side and two rows of the pixels 51 in a vicinity of a left side of the pixel array portion 41 constituted of a rectangular region are OPB pixels 51B, the numbers of rows and columns of the OPB pixels 51B can be set arbitrarily and the OPB pixels 51B need only be formed in at least a vicinity of each side of the pixel array portion 41 constituted of a rectangular region.

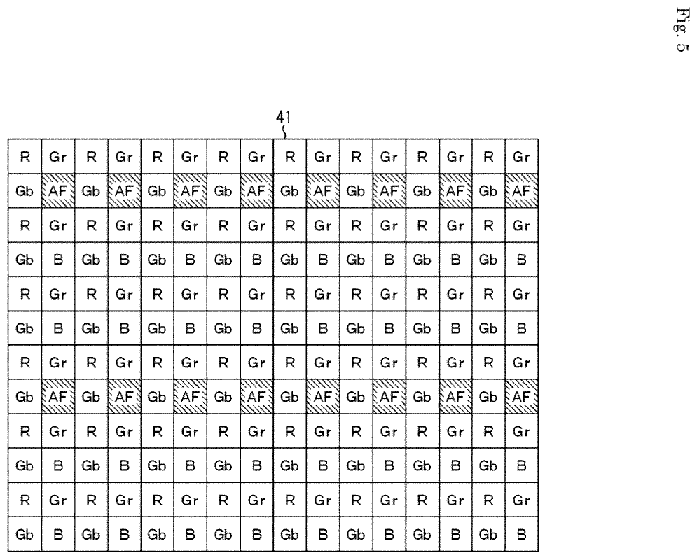

FIG. 5 is a diagram showing an array example of color filters of the pixels 51 in the pixel array portion 41.

In each pixel 51 in the pixel array portion 41, for example, as shown in FIG. 5, color filters are arrayed in a so-called Bayer array in which units of R (red), Gr (green), Gb (green), and B (blue) color filters are repetitively arrayed in the row direction and the column direction in four pixels of two pixels in the horizontal direction and two pixels in the vertical direction (2×2). The phase difference row in which the phase difference pixels 51S are arranged is arranged every five rows, and the pixels 51 which should be the B color filter in the pixel row in which Gb color filters and B color filters are arrayed in an alternating manner are replaced by the phase difference pixels 51S. While no color filter is to be formed in the phase difference pixels 51S in the present embodiment, alternatively, a color filter may be formed.

The color filter array of the pixels 51 in the pixel array portion 41 is not limited to the example shown in FIG. 5 and other arrays are possible. For example, as the color filter array, an RGB-W array may be adopted which combines and arrays, with W pixels, R pixels in which R color filters are arranged, G pixels in which G (green) color filters are arranged, and B pixels in which B (blue) color filters are arranged. The W pixel is a pixel with a W filter that transmits light of all colors (wavelengths) of R (red), G (green), and B (blue). Alternatively, as the color filter array, an RGB-IR array may be adopted which combines and arrays R pixels, G pixels, and B pixels with IR pixels. The IR pixel is a pixel with an IR filter that transmits only infrared light. The positions at which the phase difference pixels 51S are arranged are also arbitrary.

### 5. Drive Control of Live-View Mode

Next, drive control in a case where the solid-state imaging apparatus 13 operates in the live-view mode according to mode information from the control unit 14 of the imaging apparatus 1 will be described.

In the live-view mode, the solid-state imaging apparatus 13 generates and outputs a live-view image to be displayed on the display unit 16 of the imaging apparatus 1. In the live-view mode, a live-view image is generated by a thinned-out read in which a part of pixels 51 among all pixels in the pixel array portion 41 are read in a thinned-out manner. In addition, in the live-view mode, the solid-state imaging apparatus 13 detects a face area or a pupil area of a subject as an attention area and generates and outputs, as a live-view image, an image in which an area frame (area information) indicating the attention area is superimposed on the image generated by the thinned-out read.

### 5.1 Live-View Mode Drive by Comparative Drive Control

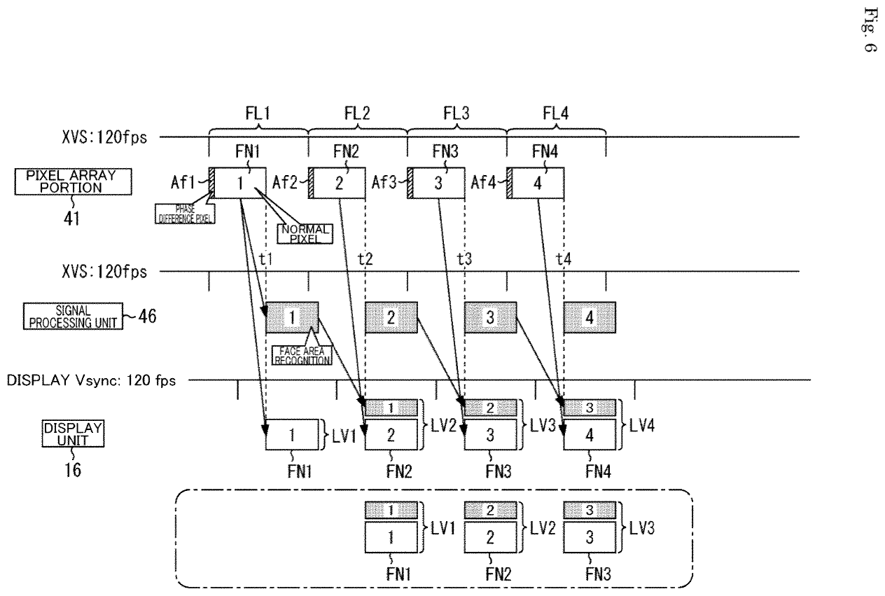

FIG. 6 is a diagram for describing drive control (hereinafter, referred to as comparative drive control) to be compared with the drive control in the live-view mode by the solid-state imaging apparatus 13. Since the comparative drive control can also be executed in the solid-state imaging apparatus 13, the comparative drive control will be described as if being performed by the solid-state imaging apparatus 13. In FIG. 6, a frequency of a vertical synchronization signal XVS is, for example, 120 Hz.

The vertical driving unit 42 performs a raster scan drive to perform a drive of reading phase difference pixels 51S and a drive of reading normal pixels 51N among all pixels 51 in the pixel array portion 41 in a time-shared manner.

Specifically, first, the vertical driving unit 42 sequentially reads the phase difference signals of the phase difference pixels 51S in row units among all pixels 51 in the pixel array portion 41. After reading the phase difference pixels 51S, the vertical driving unit 42 sequentially reads the pixel signals of the normal pixels 51N in row units by a thinned-out read.

Specifically, in a first frame period FL1, after an in plane phase difference signal Af1 of each phase difference pixel 51S is read from the pixel array portion 41, pixel signals of the normal pixels 51N constituting a photographed image FN1 for a live-view image are read.

The signal processing unit 46 executes recognition processing of detecting a face area using the photographed image FN1 after a time of day t1 at which the pixel signals of all of the normal pixels 51N constituting the photographed image FN1 are read. In addition, the signal processing unit 46 outputs an image signal of the photographed image FN1 from the output unit 48. Accordingly, the photographed image FN1 is displayed as a live-view image LV1 on the display unit 16 of the imaging apparatus 1. At this point, since the recognition processing of detecting a face area of the photographed image FN1 has not been completed, area information indicating the face area is not superimposed on the live-view image LV1.

In a subsequent second frame period FL2, after an in-plane phase difference signal Af2 of each phase difference pixel 51S is read from the pixel array portion 41, pixel signals of the normal pixels 51N constituting a photographed image FN2 for a live-view image are read.

The signal processing unit 46 executes recognition processing of detecting a face area using the photographed image FN2 after a time of day t2 at which the pixel signals of all of the normal pixels 51N constituting the photographed image FN2 are read. In addition, the signal processing unit 46 outputs an image signal of the photographed image FN2 from the output unit 48. In doing so, the signal processing unit 46 outputs an image signal in which an area frame indicating the face area being a processing result of the recognition processing performed with respect to the photographed image FN1 is superimposed on the photographed image FN2. Accordingly, a live-view image LV2 in which a face area frame being a result of recognition processing of the photographed image FN1 is superimposed on the photographed image FN2 is displayed on the display unit 16 of the imaging apparatus 1.

In a subsequent third frame period FL3, after an in-plane phase difference signal Af3 of each phase difference pixel 51S is read from the pixel array portion 41, pixel signals of the normal pixels 51N constituting a photographed image FN3 for a live-view image are read.

The signal processing unit 46 executes recognition processing of detecting a face area using the photographed image FN3 after a time of day t3 at which the pixel signals of all of the normal pixels 51N constituting the photographed image FN3 are read. In addition, the signal processing unit 46 outputs an image signal of the photographed image FN3 from the output unit 48. In doing so, the signal processing unit 46 outputs an image signal in which an area frame indicating the face area being a processing result of the recognition processing performed with respect to the photographed image FN2 is superimposed on the photographed image FN3. Accordingly, a live-view image LV3 in which a face area frame being a result of recognition processing of the photographed image FN2 is superimposed on the photographed image FN3 is displayed on the display unit 16 of the imaging apparatus 1.

The drive by the pixel array portion 41 and the processing by the signal processing unit 46 are similarly executed in a fourth frame period FL4 and thereafter.

As described above, in the comparative drive control, since face recognition processing is executed after reading a photographed image FN for a live-view image, a face area frame that represents a result the recognition processing is superimposed on the photographed image FN of one frame later. Therefore, when the subject is moving at high speed, a discrepancy may arise between the subject position in the photographed image FN and the face area frame. When preventing an occurrence of a discrepancy between the subject position and the face area frame, for example, as shown in a frame drawn by a dashed-dotted line in FIG. 6, the live-view image LV synchronizing the photographed image FN with the recognition processing result may be generated by delaying output of the photographed image FN for one frame period and the generated live-view image LV may be output to the imaging apparatus 1. However, in this case, since the display is delayed by one frame period, real-time performance of the live-view image LV declines.

### 5.2 Live-View Mode Drive by Solid-State Imaging Apparatus

Next, drive control (hereinafter, referred to as present drive control) in the live-view mode to be executed by the solid-state imaging apparatus 13 will be described.

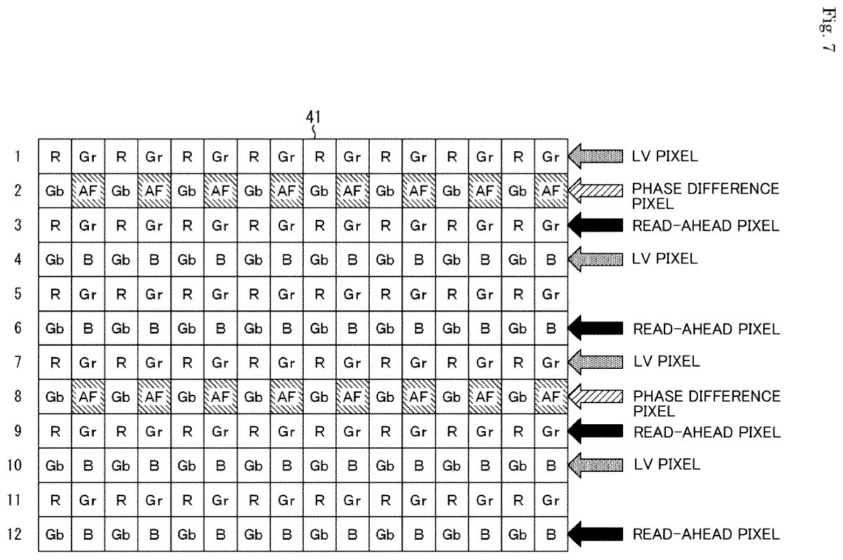

FIG. 7 shows an array of the pixel array portion 41 shown in FIG. 5. In addition, for the sake of description, numerals indicating row numbers of the pixel array portion 41 are described on a left side of the pixel array portion 41.

The system control unit 45 of the solid-state imaging apparatus 13 sets LV pixels 51N from among the normal pixels 51N excluding the phase difference pixels 51S in the pixel array portion 41. The LV pixels 51N are the normal pixels 51N that are read for a live-view image.

In addition, the system control unit 45 sets read-ahead pixels 51N from among the normal pixels 51N excluding the phase difference pixels 51S in the pixel array portion 41. The read-ahead pixels 51N are the normal pixels 51N that are read before the LV pixels 51N for recognition processing.

While the same pixel as the LV pixels 51N can be used as the read-ahead pixels 51N, in the example shown in FIG. 7, the read-ahead pixels 51N are pixels that differ from the LV pixels 51N. In this case, conditions such as gain and shutter speed can be set separately for the read-ahead pixels 51N and the LV pixels 51N.

First, the system control unit 45 sets a pixel row in which the phase difference pixels 51S are arranged as a phase difference row from which a phase difference signal is to be read. Next, the system control unit 45 sets pixel rows of the LV pixels 51N for the live view image at three-row intervals (every two rows) and pixel rows of the read-ahead pixels 51N for the recognition processing at three-row intervals (every two rows).

In the example shown in FIG. 7, phase difference rows are set in row 2, row 8, row 14 (not illustrated), . . . . LV pixel rows that are pixel rows of the LV pixels 51N are set in row 1, row 4, row 7, row 10, . . . . Read ahead pixel rows that are pixel rows of the read-ahead pixels 51N are set in row 3, row 6, row 9, row 12, . . . . Row 5, row 11, . . . are pixel rows that are not read in the live-view mode.

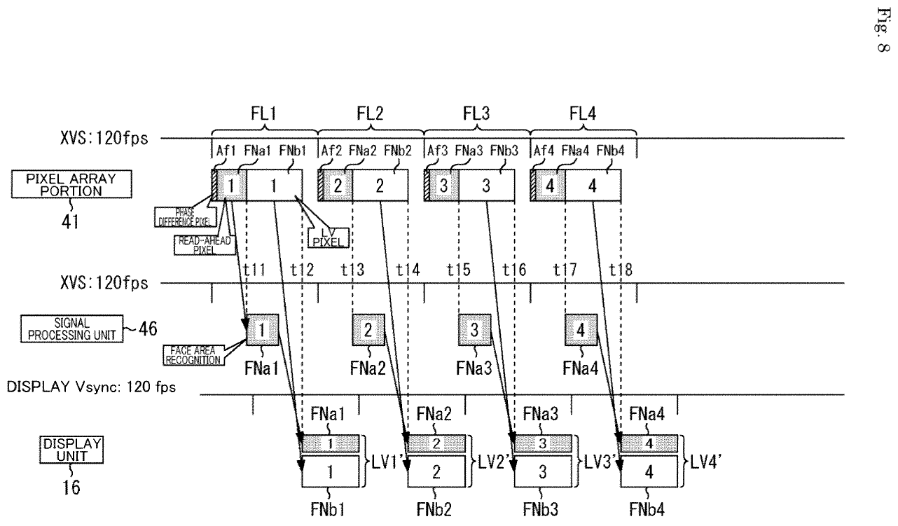

FIG. 8 is a diagram showing the present drive control in frame units. In FIG. 8, a frequency of a vertical synchronization signal XVS is, for example, 120 Hz.

In a similar manner to the comparative drive control described with reference to FIG. 6, the drive for reading the phase difference pixels 51S is performed in a time-shared manner before the drive for reading the normal pixels 51N. First, the vertical driving unit 42 sequentially reads the phase difference signals of the phase difference pixels 51S in row units among all pixels 51 in the pixel array portion 41 by a raster scan drive. Next, the vertical driving unit 42 sequentially reads a read-ahead pixel row being a pixel row of the read-ahead pixels 51N in row units. Next, the vertical driving unit 42 sequentially reads an LV pixel row being a pixel row of the LV pixels 51N in row units.

Specifically, in a first frame period FL1, first, after an in plane phase difference signal Af1 of each phase difference pixel 51S is read from the pixel array portion 41, pixel signals of the read-ahead pixels 51N constituting an image FNa1 for recognition processing are read. After reading of the pixel signals of the read-ahead pixels 51N is completed, pixel signals of the LV pixels 51N constituting a photographed image FNb1 for a live-view image are read.

The signal processing unit 46 executes recognition processing of detecting a face area using the image FNa1 after a time of day t11 at which the pixel signals of all of the read-ahead pixels 51N constituting the image FNa1 for recognition processing are read.

Face recognition processing of the image FNa1 by the signal processing unit 46 is completed by a time of day t12 at which pixel signals of all LV pixels 51N constituting a photographed image FNb1 for a live-view image are supplied to the signal processing unit 46. At the time of day t12, the signal processing unit 46 outputs an image signal in which a face area frame being a processing result of the face recognition processing performed using the image FNa1 is superimposed on the photographed image FNb1. Accordingly, a live-view image LV1′ in which a face area frame being a result of recognition processing of the image FNa1 is superimposed on the photographed image FNb1 is displayed on the display unit 16 of the imaging apparatus 1.

In a subsequent second frame period FL2, after an in-plane phase difference signal Af2 of each phase difference pixel 51S is read from the pixel array portion 41, pixel signals of the read-ahead pixels 51N constituting an image FNa2 for recognition processing are read. After reading of the pixel signals of the read-ahead pixels 51N is completed, pixel signals of the LV pixels 51N constituting a photographed image FNb2 for a live-view image are read.

The signal processing unit 46 executes recognition processing of detecting a face area using the image FNa2 after a time of day t13 at which the pixel signals of all of the read-ahead pixels 51N constituting the image FNa2 for recognition processing are read.

Face recognition processing of the image FNa2 by the signal processing unit 46 is completed by a time of day t14 at which pixel signals of all LV pixels 51N constituting the photographed image FNb2 for a live-view image are supplied to the signal processing unit 46. At the time of day t14, the signal processing unit 46 outputs an image signal in which a face area frame being a processing result of the face recognition processing performed using the image FNa2 is superimposed on the photographed image FNb2. Accordingly, a live-view image LV2′ in which a face area frame being a result of recognition processing of the image FNa2 is superimposed on the photographed image FNb2 is displayed on the display unit 16 of the imaging apparatus 1.

In a subsequent third frame period FL3, after an in-plane phase difference signal Af3 of each phase difference pixel 51S is read from the pixel array portion 41, pixel signals of the read-ahead pixels 51N constituting an image FNa3 for recognition processing are read. After reading of the pixel signal of the read-ahead pixel 51N is completed, pixel signals of the LV pixels 51N constituting a photographed image FNb3 for a live-view image are read.

The signal processing unit 46 executes recognition processing of detecting a face area using the image FNa3 after a time of day t15 at which the pixel signals of all of the read-ahead pixels 51N constituting the image FNa3 for recognition processing are read.

Face recognition processing of the image FNa3 by the signal processing unit 46 is completed by a time of day t16 at which pixel signals of all LV pixels 51N constituting a photographed image FNb3 for a live-view image are supplied to the signal processing unit 46. At the time of day t16, the signal processing unit 46 outputs an image signal in which a face area frame being a processing result of the face recognition processing performed using the image FNa3 is superimposed on the photographed image FNb3. Accordingly, a live-view image LV3′ in which a face area frame being a result of recognition processing of the image FNa3 is superimposed on the photographed image FNb3 is displayed on the display unit 16 of the imaging apparatus 1.

The drive by the pixel array portion 41 and the processing by the signal processing unit 46 are similar executed in a fourth frame period FL4 and thereafter.

As described above, by performing reading of pixel signals of the read-ahead pixels 51N constituting an image FNa1 and recognition processing using the image FNa1 before reading of pixel signals of the LV pixels 51N constituting a photographed image FNb for a live-view image is completed, the solid-state imaging apparatus 13 can ensure that the recognition processing is completed by the time reading of the pixel signals of the LV pixels 51N for the live-view image is completed. Accordingly, a face area frame of a recognition processing result of the same frame period FL without a delay can be superimposed on the photographed image FNb for a live-view image.

### 5.3 Processing Flow of Live-View Mode Drive Control

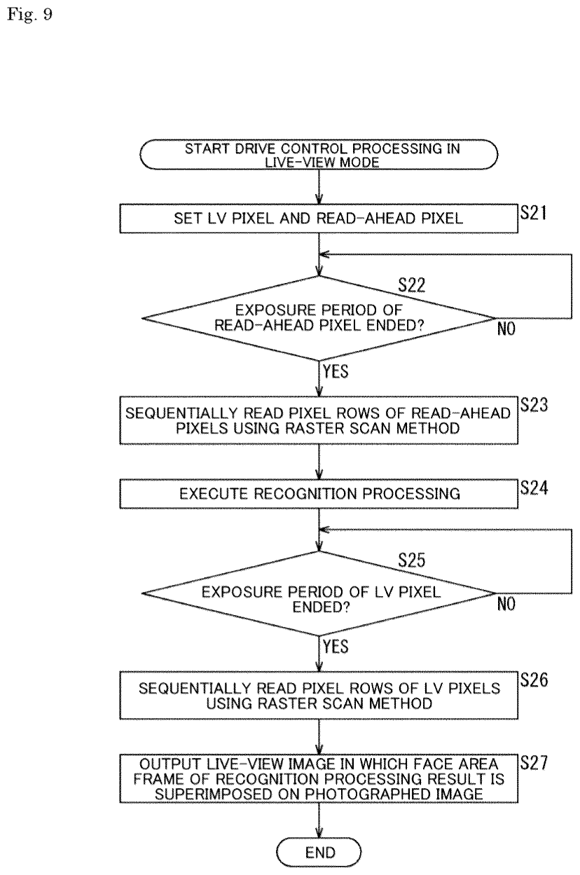

Next, drive control processing by the solid-state imaging apparatus 13 in the live-view mode will be described with reference to the flow chart shown in FIG. 9.

For example, the processing is started when the operating mode of the solid-state imaging apparatus 13 is set to the live-view mode and an instruction to start photography is issued from the control unit 14 of the imaging apparatus 1. The flow chart shown in FIG. 9 corresponds to drive control processing of generating one live-view image. Note that the flow chart shown in FIG. 9 omits a portion regarding the drive for reading the phase difference signals of the phase difference pixels 51S.

First, in step S21, the system control unit 45 of the solid-state imaging apparatus 13 sets the LV pixels 51N for a live-view image and the read-ahead pixels 51N to be read for recognition processing before the LV pixels 51N from among the normal pixels 51N in the pixel array portion 41.

While an example in which pixel rows of the LV pixels 51N are set at three-row intervals (every two rows) and pixel rows of the read-ahead pixels 51N are set at three-row intervals (every two rows) among all pixels of the pixel array portion 41 has been described above, settings of the LV pixels 51N and the read-ahead pixels 51N are not limited thereto. For example, pixel rows of the LV pixels 51N may be set at six row intervals (every five rows) and pixel rows of the read-ahead pixels 51N may be set at six-row intervals (every five rows).

In addition, the intervals between pixel rows of the LV pixels 51N and the intervals between pixel rows of the read-ahead pixels 51N need not be the same and can be set to different values. The pixel rows of the LV pixels 51N can be set to a predetermined thinning rate for generating a live-view image. The pixel rows of the read-ahead pixels 51N can be set to a predetermined thinning rate in accordance with contents of processing such as an object to be recognized or detected. For example, the system control unit 45 can set three-row intervals with a thinning ratio of 1/3 when performing pupil recognition, six row intervals with a thinning ratio of 1/6 when performing face recognition, and 18-row intervals with a thinning ratio of 1/18 when performing color recognition of an entire image. Once the LV pixels 51N and the read-ahead pixels 51N are set, the vertical driving unit 42 starts exposure of each pixel 51 that is a read object of the pixel array portion 41.

In step S22, the vertical driving unit 42 determines whether or not an exposure period of the read-ahead pixels 51N has ended and stands by until a determination that the exposure period has ended is made. In addition, in step S22, when it is determined that the exposure period of the read-ahead pixels 51N has ended, the processing advances to step S23 and the vertical driving unit 42 sequentially reads pixel rows of read-ahead pixels 51N using a raster scan method.

In step S24, the signal processing unit 46 executes recognition processing using an image FNa constituted of pixel signals of the read read-ahead pixels 51N. For example, face area recognition processing of detecting a face area in the image FNa is executed as the recognition processing.

In step S25, the vertical driving unit 42 determines whether or not an exposure period of the LV pixels 51N has ended and stands by until a determination that the exposure period has ended is made. In addition, in step S25, when it is determined that the exposure period of the LV pixels 51N has ended, the processing advances to step S26 and the vertical driving unit 42 sequentially reads pixel rows of the LV pixels 51N using a raster scan method.

In step S27, the signal processing unit 46 generates a live-view image LV′ in which a face area frame that is a recognition processing result of the image FNa of the same frame period FL is superimposed on the photographed image FNb constituted of the pixel signals of the LV pixels 51N and outputs the generated live-view image LV′ to the image processing unit 15 in a subsequent stage.

Accordingly, the drive control processing shown in FIG. 9 is completed. The processing of step S21 to step S27 is processing corresponding to one live-view image LV′ and the drive control processing shown in FIG. 9 is repetitively executed in each frame period.

While an example in which pixels that differ from the LV pixels 51N for a live-view image are used as the read-ahead pixels 51N has been described above, alternatively, the same pixels as the LV pixels 51N may be set. In such a case, pixel signals as the LV pixels 51N for a live-view image can be generated by interpolation processing using at least one of pixel signals when read in advance as the read-ahead pixels 51N and surrounding pixel signals of the read-ahead pixels 51N.

In FIG. 3, a pixel circuit capable of operation (imaging) according to a global shutter system has been described as a circuit configuration of the pixel 51. In pixel drive according to the global shutter system, when conditions such as gain and shutter speed are set the same for the read-ahead pixel 51N and the LV pixel 51N, the pixel signal of the read-ahead pixel 51N can be used as-is as the pixel signal of the LV pixel 51N.

### 6. Conclusion

As described above, the solid-state imaging apparatus 13 includes the pixel array portion 41 in which two types of pixels 51, namely, the normal pixels 51N and the phase difference pixels 51S, are two-dimensionally arranged in a matrix pattern, the vertical driving unit 42 that controls read of signals generated by the pixels 51, and the signal processing unit 46 that generates a photographed image (live-view image) using the read signals of the pixels 51. The vertical driving unit 42 reads a part of the normal pixels 51N of the pixel array portion 41 in advance as read-ahead pixels 51N (first pixels) and, after the read-ahead pixels 51N, reads a part of the normal pixels 51N of the pixel array portion 41 as LV pixels 51N (second pixels). The signal processing unit 46 performs processing of reflecting a processing result of processing using the read-ahead pixels 51N in a photographed image (live-view image) using the LV pixels 51N. Accordingly, processing of reflecting in the photographed image (live-view image) can be executed without a lag from displaying the photographed image.

As processing of reflecting a processing result of processing using the read-ahead pixels 51N in a photographed image, for example, when the processing using the read-ahead pixels 51N is recognition processing of recognizing a face or a pupil, the signal processing unit 46 executes processing of superimposing the processing result (such as a face area frame) of the recognition processing on the photographed image. In addition, for example, when the processing using the read-ahead pixels 51N is color recognition processing of recognizing the color of an entire image, the signal processing unit 46 executes white balance correction processing of reflecting a processing result of the color recognition processing in a photographed image as processing of reflecting in a photographed image.

While examples of face recognition processing, pupil recognition processing, and color recognition processing have been described above as processing using the read-ahead pixels 51N, the processing using the read-ahead pixels 51N is not limited to recognition processing. For example, the processing may be processing of detecting an object inside of a photographed image or processing of detecting exposure conditions or the like. In addition, while the pixel array portion 41 is configured to include the normal pixels 51N and the phase difference pixels 51S in the examples described above, the pixel array portion 41 may be configured so as not to include the phase difference pixels 51S and only the normal pixels 51N are two-dimensionally arranged in a matrix pattern.

### 7. Example of Use of Image Sensor

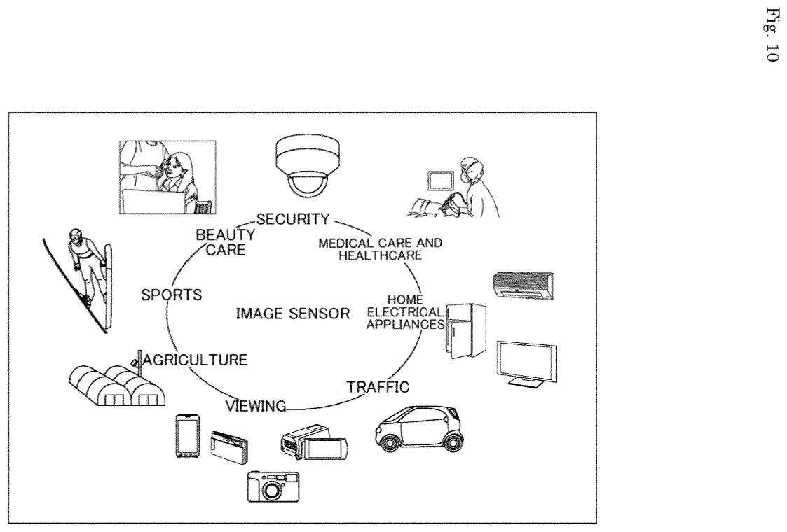

FIG. 10 is a diagram showing an example of use of an image sensor using the solid-state imaging apparatus 13 described above.

For example, as described below, the solid-state imaging apparatus 13 described above can be used as an image sensor in various cases where sensing of light such as visible light, infrared light, ultraviolet light, or X-rays is performed.
Apparatuses for photographing images to be used for applications for viewing such as a digital camera and a mobile device with a camera function
Apparatuses for applications in transportation such as a vehicle-mounted sensor that photographs the front, the rear, a periphery, an interior, or the like of an automobile for purposes of safe driving including automatic braking and recognition of a state of a driver, a monitoring camera that monitors traveling vehicles or a road, and a ranging sensor that measures distances between vehicles and the like
Apparatuses to be used in home electrical appliances such as a TV, a refrigerator, and an air conditioner which photograph a gesture made by a user and perform device operation in accordance with the gesture
Apparatuses for applications in medical care and healthcare such as an endoscope and an apparatus that performs angiography by receiving infrared light
Apparatuses for applications in security such as a surveillance camera for crime prevention applications and a camera for person authentication applications
Apparatuses for applications in beauty care such as a skin measuring device that photographs skin and a microscope that photographs the scalp
Apparatuses for applications in sports such as an action camera or a wearable camera for sports applications
Apparatuses for applications in agriculture such as a camera for monitoring a state of a field or crops

Embodiments of the present disclosure are not limited to the embodiment described above and various modifications can be made without departing from the gist of the technique according to the present disclosure. For example, a mode that combines all of or a part of the embodiment described above as appropriate can be adopted.

It should be noted that the advantageous effects described in the present specification are merely exemplary and are not restrictive, and advantageous effects other than those described in the present specification may be produced.

The technique according to the present disclosure can also adopt the following configurations.
(1)

A solid-state imaging apparatus, including:
a pixel array portion configured to have a plurality of pixels that is two-dimensionally arranged in a matrix pattern;
a driving unit configured to control reading of signals generated by the pixels; and
a signal processing unit configured to generate a photographed image using the read signals of the pixels, wherein
the driving unit reads first pixels that are a part of the pixels in the pixel array portion first, and to read, after the first pixels, second pixels that are a part of the pixels in the pixel array portion, and
the signal processing unit performs processing of reflecting a processing result of processing using the first pixels in the photographed image using the second pixels.
(2)

The solid-state imaging apparatus according to (1) above, wherein
the pixels include normal pixels that are pixels that acquire and output a pixel signal for video output and phase difference pixels that are pixels that output a phase difference signal, and
the driving unit read the normal pixels as the first pixels and the second pixels.
(3)

The solid-state imaging apparatus according to (1) or (2) above, wherein the driving unit read pixels of a pixel row set at a predetermined thinning rate as the first pixels.
(4)

The solid-state imaging apparatus according to (3) above, wherein the predetermined thinning rate is set in accordance with contents of processing using the first pixels.
(5)

The solid-state imaging apparatus according to any of (1) to (4) above, wherein the driving unit read pixels of a pixel row set at a predetermined thinning rate as the second pixels.
(6)

The solid-state imaging apparatus according to any of (1) to (5) above, wherein the driving unit read pixels that differ from the second pixels as the first pixels.
(7)

The solid-state imaging apparatus according to any of (1) to (5) above, wherein the driving unit read pixels that are the same as the second pixels as the first pixels.
(8)

The solid-state imaging apparatus according to (7) above, wherein the signal processing unit use, when same pixels as the second pixels are read as the first pixels, signals of the first pixels as-is as signals of the second pixels.
(9)

The solid-state imaging apparatus according to (7) above, wherein the signal processing unit generate, when same pixels as the second pixels are read as the first pixels, signals of the second pixels by interpolation processing.
(10)

A control method of a solid-state imaging apparatus including a pixel array portion configured to have a plurality of pixels that is two-dimensionally arranged in a matrix pattern, and a signal processing unit, the method including: the driving unit reading first pixels that are a part of the pixels in the pixel array portion first and reading, after the first pixels, second pixels that are a part of the pixels in the pixel array portion, and
the signal processing unit performing processing of reflecting a processing result of processing using the first pixels in a photographed image using the second pixels.
(11)

An electronic device including
a solid-state imaging apparatus including:
a pixel array portion configured to have a plurality of pixels that is two-dimensionally arranged in a matrix pattern;
a driving unit configured to control reading of signals generated by the pixels; and
a signal processing unit configured to generate a photographed image using the read signals of the pixels, wherein
the driving unit read first pixels that are a part of the pixels in the pixel array portion first, and to read, after the first pixels, second pixels that are a part of the pixels in the pixel array portion, and
the signal processing unit perform processing of reflecting a processing result of processing using the first pixels in the photographed image using the second pixels.

### REFERENCE SIGNS LIST

1 Imaging apparatus
13 Solid-state imaging apparatus
14 Control unit
15 Image processing unit
16 Display unit
17 Recording unit
41 Pixel array portion
42 Vertical driving unit
43 Column processing unit
44 Horizontal driving unit
45 System control unit
46 Signal processing unit
47 Data storage unit
48 Output unit
51 Pixel
51N Normal pixel (read-ahead pixel, LV pixel)
51S Phase difference pixel
51B OPB pixel
101 Effective pixel region
102 OPB pixel region
FL1 First frame period
FL2 Second frame period
FL3 Third frame period
FL4 Fourth frame period
FNa (FNa1, FNa2, FNa3, FNa4) Image
FNb (FNb1, FNb2, FNb3, FNb4) Photographed image
LV′ (LV1′, LV2′, LV3′, LV4′) Live-view image

1. A solid-state imaging apparatus comprising:
a pixel array portion configured to have a plurality of pixels that is two-dimensionally arranged in a matrix pattern;
a driving unit configured to control reading of signals generated by the pixels; and
a signal processing unit configured to generate a photographed image using the read signals of the pixels, wherein
the driving unit reads first pixels that are a part of the pixels in the pixel array portion first, and to read, after the first pixels, second pixels that are a part of the pixels in the pixel array portion, and
the signal processing unit performs processing of reflecting a processing result of processing using the first pixels in the photographed image using the second pixels.

2. The solid-state imaging apparatus according to claim 1, wherein the pixels include normal pixels that are pixels that acquire and output a pixel signal for video output and phase difference pixels that are pixels that output a phase difference signal, and
the driving unit read the normal pixels as the first pixels and the second pixels.

3. The solid-state imaging apparatus according to claim 1, wherein
the driving unit read pixels of a pixel row set at a predetermined thinning rate as the first pixels.

4. The solid-state imaging apparatus according to claim 3, wherein the predetermined thinning rate is set in accordance with contents of processing using the first pixels.

5. The solid-state imaging apparatus according to claim 1, wherein the driving unit read pixels of a pixel row set at a predetermined thinning rate as the second pixels.

6. The solid-state imaging apparatus according to claim 1, wherein the driving unit read pixels that differ from the second pixels as the first pixels.

7. The solid-state imaging apparatus according to claim 1, wherein the driving unit read pixels that are the same as the second pixels as the first pixels.

8. The solid-state imaging apparatus according to claim 7, wherein the signal processing unit use, when same pixels as the second pixels are read as the first pixels, signals of the first pixels as-is as signals of the second pixels.

9. The solid-state imaging apparatus according to claim 7, wherein the signal processing unit generate, when same pixels as the second pixels are read as the first pixels, signals of the second pixels by interpolation processing.

10. A control method of a solid-state imaging apparatus including a pixel array portion configured to have a plurality of pixels that is two-dimensionally arranged in a matrix pattern, a driving unit, and a signal processing unit, the method comprising:
the driving unit reading first pixels that are a part of the pixels in the pixel array portion first and reading, after the first pixels, second pixels that are a part of the pixels in the pixel array portion, and
the signal processing unit performing processing of reflecting a processing result of processing using the first pixels in a photographed image using the second pixels.

11. An electronic device, comprising
a solid-state imaging apparatus including:
a pixel array portion configured to have a plurality of pixels that is two-dimensionally arranged in a matrix pattern;
a driving unit configured to control reading of signals generated by the pixels; and
a signal processing unit configured to generate a photographed image using the read signals of the pixels, wherein
the driving unit reads first pixels that are a part of the pixels in the pixel array portion first, and to read, after the first pixels, second pixels that are a part of the pixels in the pixel array portion, and
the signal processing unit performs processing of reflecting a processing result of processing using the first pixels in the photographed image using the second pixels.
